(19) United States
(12) Patent Application Publication
(10) Pub. No.: US 2007/0061732 A1
(43) Pub. Date: Mar. 15, 2007

(54) User interface options of an impact analysis tool

(76) Inventors: Nathan Vernon Bobbin, Littleton, CO (US); Alexei B. Fedotov, Newton, MA (US); William Richard Swanson, Boston, MA (US); Steven John Totman, Watertown, MA (US); Michael W. Yaklin, Austin, TX (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(21) Appl. No.: 11/224,868

(22) Filed: Sep. 12, 2005

(51) Int. Cl. G06F 9/00

(52) U.S. Cl. 715/739; 715/838

(57) ABSTRACT

Provided are a techniques for viewing objects. An impact analysis view that includes at least one impact analysis path from an original object to a first selected object is displayed. The impact analysis view is output from an impact analysis tool that analyzes how change to the original object impacts other objects. The at least one impact analysis path includes objects through which the original object and selected object are related. The impact analysis view is displayed as a fish eye view.

### BACKGROUND

1. Field

Embodiments of the invention relate to user interface options of an impact analysis tool.

2. Description of the Related Art

Impact analysis tools allow users to understand dependencies between objects (e.g., database objects, such as tables and columns) by providing a User Interface (UI) depicting objects and their relationships. The output of an impact analysis tool may be referred to as an impact analysis view. An impact analysis view may include one or more impact analysis paths, and each impact analysis path describes a relationship of an original object and a selected object with a set of objects through which the original object and selected object are related. FIG. 1 illustrates a portion of a prior art impact analysis view 100 that was output by an impact analysis tool. In this example, the impact analysis tool performed impact analysis on an RVFHOA_Analytics object 110. The impact analysis tool generated the impact analysis view 100, illustrates the dependencies between a RVFHOA_Analytics object and various databases (e.g., RVFHOA01), tables (e.g., Reconciliation), and columns (e.g., ReconciliationID, InvoiceITemId, and PaymentID). That is, the impact analysis view illustrates objects that are likely to be impacted or affected by any change to a first object (e.g., the RVFHOA_Analytics object 110 in this example). An impact analysis path may be described as a set of associated objects that indicate the objects that may be impacted or affected by a change to a particular object in the impact analysis path. For example, in FIG. 1, one impact analysis path is: RVFHOA_Analytics—Reconciliation—ReconciliationID. In this example impact analysis path, the RVFHOA_Analytics object 110 has a table named Reconciliation, which includes a column named Reconciliation_ID. The Reconciliation table and Reconciliation_ID column may be impacted by changes to the RVFHOA_Analytics object 110.

Conventional impact analysis tools are useful, but have limitations. For example, impact analysis tools are useful in enabling quantification of the impact of a proposed change (e.g., addition of a new table), and, thus, reduce the uncertainty of implementing that proposed change. However, conventional impact analysis tools provide a macro view, which results in the impact analysis view including all of the information output by the impact analysis tool so that only a portion of the impact analysis view is visible on a computer screen, and a user is required to use a scrollbar to view different portions of the impact analysis view. Thus, with a macro view, there may be information overload for a user. With display of such an unfiltered impact analysis view, object relationships may be difficult to identify. Thus, users are required to manage the computer screen real estate (i.e., the portion of the computer screen on which the macro view is displayed). In some conventional impact analysis tools, the manner in which the (User Interface) UI is displayed may be as complex as the nature of the relationships that are being displayed. Interpreting this complex UI display may result in a user misinterpreting the impact analysis output.

Thus, there is a need in the art for improved usability of an impact analysis tool.

### SUMMARY OF EMBODIMENTS OF THE INVENTION

Provided are a method, computer program product, and system for viewing objects. An impact analysis view that includes at least one impact analysis path from an original object to a first selected object is displayed. The impact analysis view is output from an impact analysis tool that analyzes how change to the original object impacts other objects. The at least one impact analysis path includes objects through which the original object and selected object are related. The impact analysis view is displayed as a fish eye view

### BRIEF DESCRIPTION OF THE DRAWINGS

Referring now to the drawings in which like reference numbers represent corresponding parts throughout:

FIG. 1 illustrates a portion of a prior art display from an impact analysis tool.

FIG. 2 illustrates details of a computing device in accordance with certain embodiments.

FIGS. 3A, 3B, and 3C illustrate logic performed by the impact analysis system 224 in accordance with certain embodiments.

FIG. 4 illustrates an impact analysis output in accordance with certain embodiments.

FIG. 5 illustrates an impact analysis path from an original object to a selected object in accordance with certain embodiments.

FIG. 6 illustrates impact analysis paths from an original object to multiple selected objects in accordance with certain embodiments.

FIG. 7 illustrates collapse of objects in accordance with certain embodiments.

FIG. 8 illustrates a container that includes collapsed objects in accordance with certain embodiments.

FIG. 9 illustrates a “Full size” option view in accordance with certain embodiments.

FIG. 10 illustrates a text view in accordance with certain embodiments.

FIGS. 11A, 11B, and 11C illustrate an object being rolled over in accordance with certain embodiments.

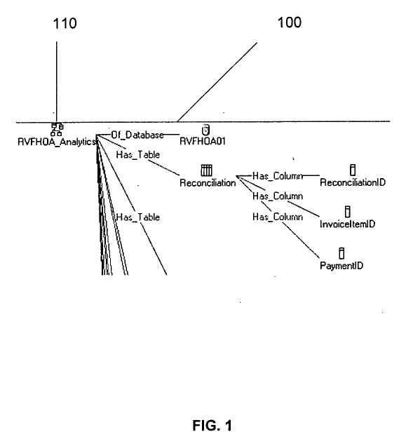

### DETAILED DESCRIPTION

In the following description, reference is made to the accompanying drawings which form a part hereof and which illustrate several embodiments of the invention. It is understood that other embodiments may be utilized and structural and operational changes may be made without departing from the scope of the invention.

Embodiments visually display object relationships in a clear manner as part of the impact analysis view, provide options for displaying macro and micro views of objects and their dependencies, enable recursive filtering to limit objects and relationships that are displayed, provide a summarized view of objects by class that is easy to browse and filter, and provide display options to manage the impact analysis view.

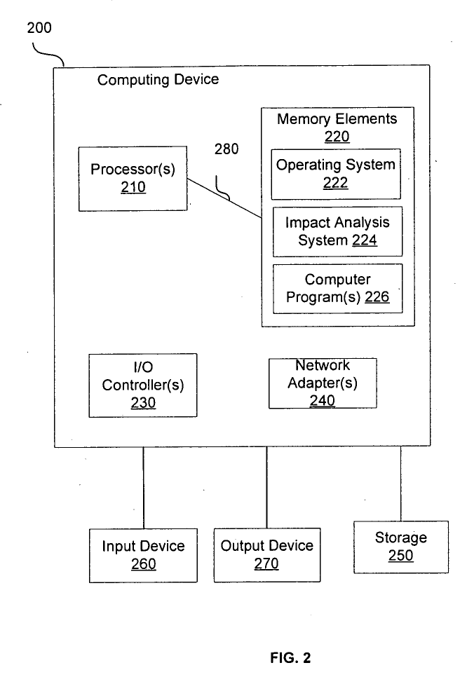

FIG. 2 illustrates details of a computing device 200 in accordance with certain embodiments. The computing device 200 is suitable for storing and/or executing program code and includes at least one processor 210 coupled directly or indirectly to memory elements 220 through a system bus 280. The memory elements 220 may include local memory employed during actual execution of the program code, bulk storage, and cache memories which provide temporary storage of at least some program code in order to reduce the number of times code must be retrieved from bulk storage during execution. The memory elements 220 include an operating system 222, an impact analysis system 224, and one or more other computer programs 226.

Input/output or I/O devices 260, 270 (including but not limited to keyboards, displays, pointing devices, etc.) may be coupled to the system either directly or through intervening I/O controllers 230.

Network adapters 240 may also be coupled to the system to enable the data processing system to become coupled to other data processing systems or remote printers or storage devices through intervening private or public networks. Modems, cable modem and Ethernet cards are just a few of the currently available types of network adapters 240.

The computing device 200 may be coupled to storage 250 (e.g., a non-volatile storage area, such as magnetic disk drives, optical disk drives, a tape drive, etc.). The storage 230 may comprise an internal storage device or an attached or network accessible storage. Computer programs 226 in storage 230 may be loaded into the memory elements 220 and executed by a processor 210 in a manner known in the art. In certain embodiments, the storage 250 stores a database. The impact analysis system 224 may store and retrieve data from the database.

The computing device 200 may include fewer components than illustrated, additional components not illustrated herein, or some combination of the components illustrated and additional components. The computing device 200 may comprise any computing device known in the art, such as a mainframe, server, personal computer, workstation, laptop, handheld computer, telephony device, network appliance, virtualization device, storage controller, etc.

In certain embodiments, the impact analysis system 224 includes a collection of tools for investigating and analyzing impact analysis paths between objects. The impact analysis system 224 provides a User Interface (UI) that continually and dynamically adjusts the visual presentation of objects in an impact analysis view to modify impact analysis paths between user-selected objects and offers a number of user-controlled options for compressing the visual presentation of intermediate objects in an impact analysis path. The user interface of the impact analysis system 224 also permits user drill down on objects and relationships in a displayed impact analysis path.

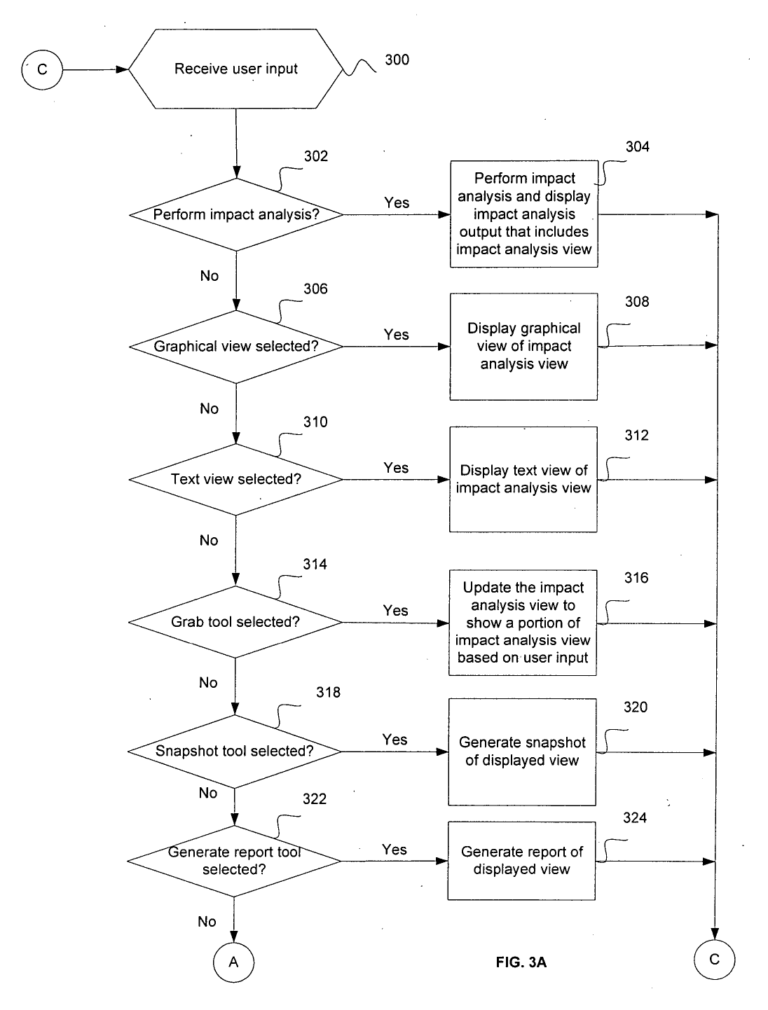

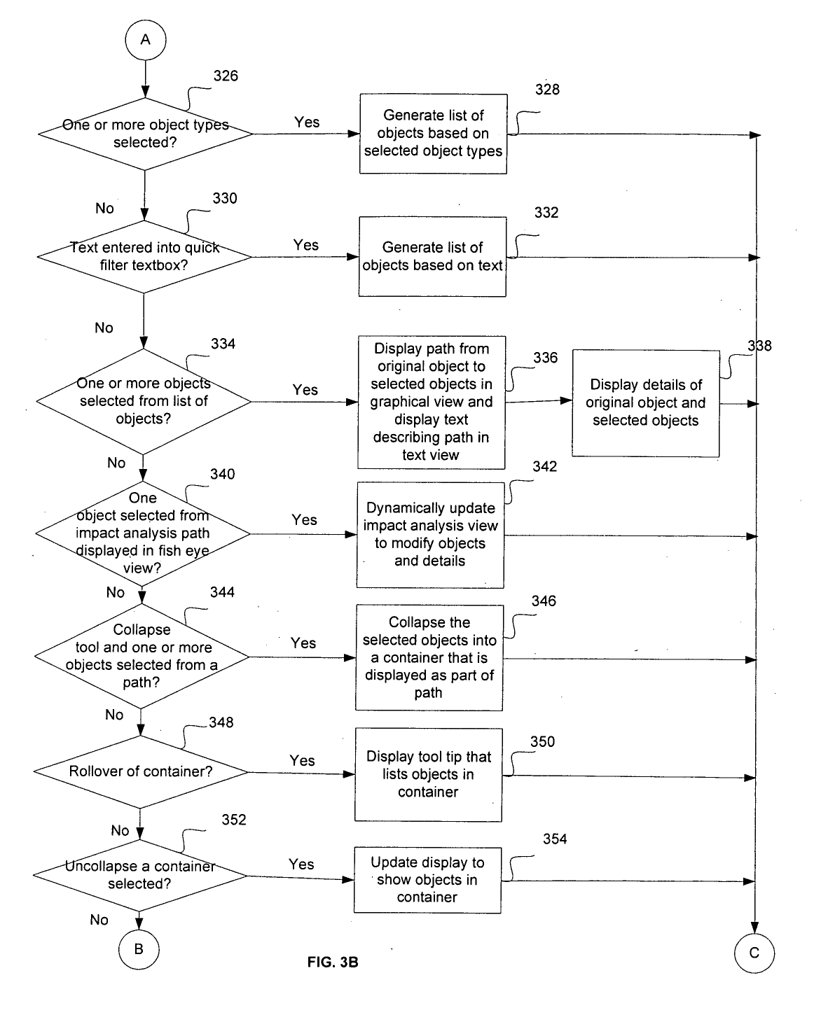

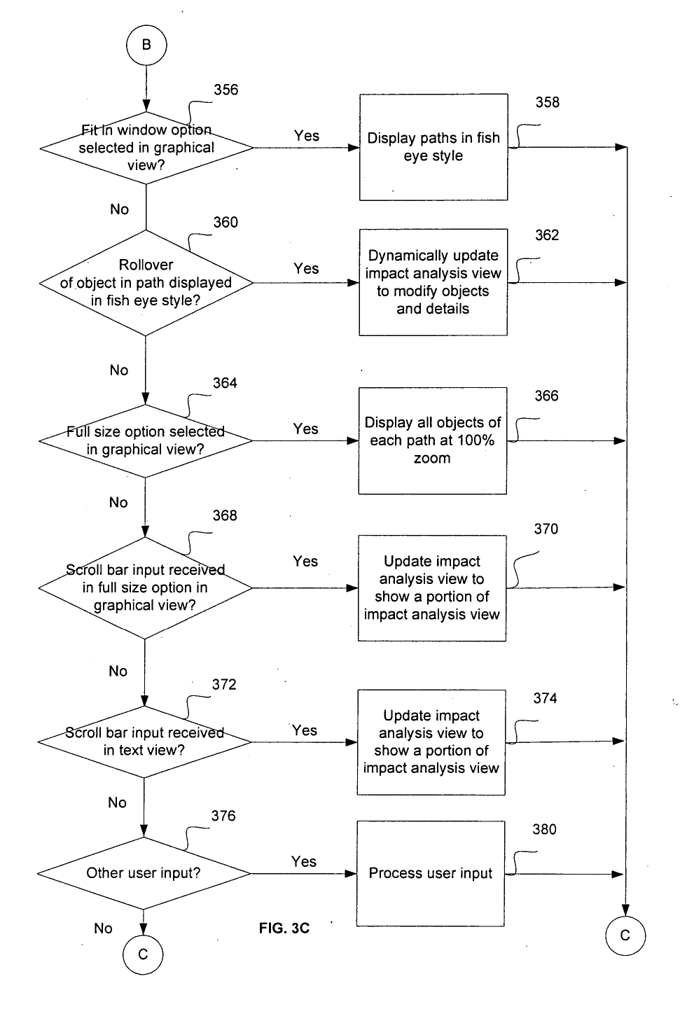

FIGS. 3A, 3B, and 3C illustrate logic performed by the impact analysis system 224 in accordance with certain embodiments. Control begins at block 300 with the impact analysis system 224 receiving user input. In block 302, the impact analysis system 224 determines whether the user input is to perform impact analysis. If so, processing continues to block 304, otherwise, processing continues to block 306. In block 304, the impact analysis system 224 performs impact analysis and displays an impact analysis output that includes an impact analysis view. From block 304, processing returns to block 300.

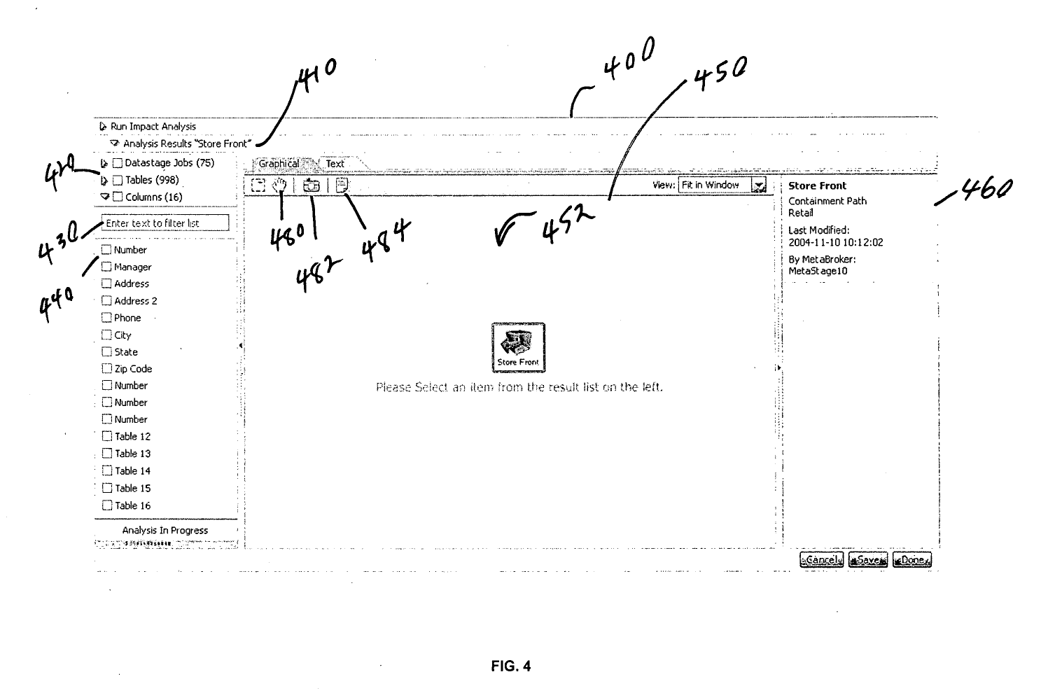

FIG. 4 illustrates an impact analysis output 400 in accordance with certain embodiments. In FIG. 4, impact analysis was run on a Store Front object (shown by text 410) that was selected by a user. The impact analysis output 400 includes a list of object types 420, a quick filter text box 430, a list of objects 440, a path area 450, and a details area 460. An impact analysis view 452 is displayed as a fish eye view within the path area 450. The impact analysis system 224 categorizes results based on object type and enables quick filtering to allow users to easily browse through the objects. The filters provided by the impact analysis system 224 include a list of object types 420 and a quick filter text box 430. In particular, the impact analysis system 224 displays the list of object types 420 with a name and number of each object type. A user may select one or more object types to show instances of the selected object types displayed in a list of objects 440. The impact analysis system 224 displays a list of objects 440 to enable a user to select one or more objects that are used to generated the impact analysis view 452 that is displayed in the path area 450. The impact analysis system 224 displays a quick filter text box 430 that enables a user to enter text to filter objects that are to be displayed in the list of objects 440. The impact analysis system 224 also provides a details area 460 which is capable of providing details (i.e., metadata and/or information) about objects that are displayed in the impact analysis view 452. In certain embodiments, the impact analysis system 224 displays the impact analysis view 452 as a graphical view in a center area as a collection of object graphics (e.g., icons) and their relationships, while details of a selected object are displayed in another (e.g., right) area of the impact analysis output. In certain other embodiments, the impact analysis system 224 displays the impact analysis view as a textual view in a center area in text format that describes a collection of objects and their relationships.

Returning to FIG. 3A, in block 306, the impact analysis system 224 determines whether the user input indicates that a graphical view has been selected. In particular, the impact analysis system 224 provides both a graphical and a text view. In a graphical view, objects are represented with graphics (e.g., icons). If so, processing continues to block 308, otherwise, processing continues to block 310. In block 308, the impact analysis system 224 displays a graphical view of the impact analysis view. For example, in FIG. 4, the graphical view tab 470 provided by the impact analysis system 224 has been selected, and the impact analysis view 452 shows a StoreFront object. From block 308, processing returns to block 300.

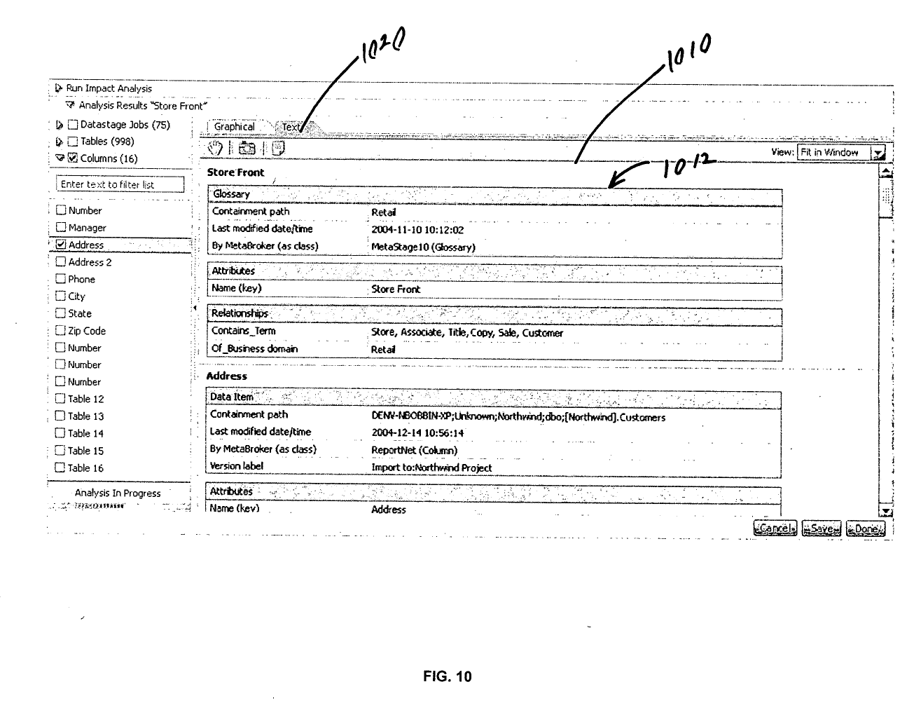

In block 310, the impact analysis system 224 determines whether the user input indicates that a text view has been selected. If so, processing continues to block 312, otherwise, processing continues to block 314. In block 312, the impact analysis system 224 displays a text view of the impact analysis view. From block 312, processing returns to block 300. FIG. 10 illustrates a text view in accordance with certain embodiments. In FIG. 10, the text view tab 1020 provided by the impact analysis system 224 has been selected. The impact analysis view 1012 displayed in path area 1010 provides a textual description of the original Store Front object, the selected Address object, and the relationship of these objects.

In block 314, the impact analysis system 224 determines whether the user input indicates that a grab tool has been selected. If so, processing continues to block 316, otherwise, processing continues to block 318. In block 316, the impact analysis system 224 updates the impact analysis view to show a portion of the impact analysis view based on the user input. From block 316, processing returns to block 300. In FIG. 4, the grab tool provided by the impact analysis system 224 is represented by a hand 480. In certain embodiments, the impact analysis system 224 implements the functionality of the grab tool by enabling a user to hold down a spacebar of a keyboard and click and drag (e.g., with an input device, such as a mouse) the background to various positions. In certain embodiments, the functionality of the grab tool may be implemented using arrow keys on the keyboard. In these manners, the user may quickly move the displayed view without the use of a scrollbar.

In block 318, the impact analysis system 224 determines whether the user input indicates that a snapshot tool has been selected. If so, processing continues to block 320, otherwise, processing continues to block 322. In block 320, the impact analysis system 224 generates a snapshot of the displayed view. From block 320, processing returns to block 300. In FIG. 4, the snapshot tool provided by the impact analysis system 224 is represented by a camera 482. In certain embodiments, the snapshot is stored in a document that may later be exported to multiple formats (e.g., Portable Document Format (PDF) format, Joint Photographic Experts Group (JPEG) format, word processing document format, etc.). In certain embodiments, the snapshot is stored in a report generated by the generate report tool.

In block 322, the impact analysis system 224 determines whether the user input indicates that a generate report tool has been selected. If so, processing continues to block 324, otherwise, processing continues to block 326 (FIG. 3B). In block 324, the impact analysis system 224 generates a report of the displayed view. From block 324, processing returns to block 300. In FIG. 4, the generate report tool provided by the impact analysis system 224 is represented by a document 484. In certain embodiments, the report may be generated in various formats (e.g., PDF format, JPEG format, word processing document format, etc.) and may include one or more snapshots. For example, in text view, the user may create a text-based document of the objects that they are interested in and quickly export or print the text-based document for reporting purposes.

In block 326 (FIG. 3B), the impact analysis system 224 determines whether the user input indicates that one or more objects have been selected from a list of objects. If so, processing continues to block 328, otherwise, processing continues to block 332. In block 328, the impact analysis system 224 generates a list of objects based on the selected object types. In FIG. 4, the column object type has been selected from the object types 420. In FIG. 4, the list of objects 440 have been generated based on the columns object type having been selected. From block 328, processing continues to block 300.

In block 330, the impact analysis system 224 determines whether text has been entered into a quick filter textbox. If so, processing continues to block 332, otherwise, processing continues to block 334. In block 332, the impact analysis system 224 generates a list of objects based on the input text. From block 332, processing continues to block 300.

In block 334, the impact analysis system 224 determines whether the user input indicates that one or more objects have been selected from a list of objects. In FIG. 4, objects may be selected from the list of objects 440. If so, processing continues to block 336, otherwise, processing continues to block 340. In block 336, the impact analysis system 224 displays an impact analysis path from an original object (i.e., the object for which impact analysis was performed) to each of the selected objects in a graphical view and displays text describing each impact analysis path in the text view. In block 338, the impact analysis system 224 also displays details of the original object and selected objects. From block 338, processing continues to block 300. In this manner, a user selects one or more objects to view and/or analyze from a categorized, browsable, and filterable list.

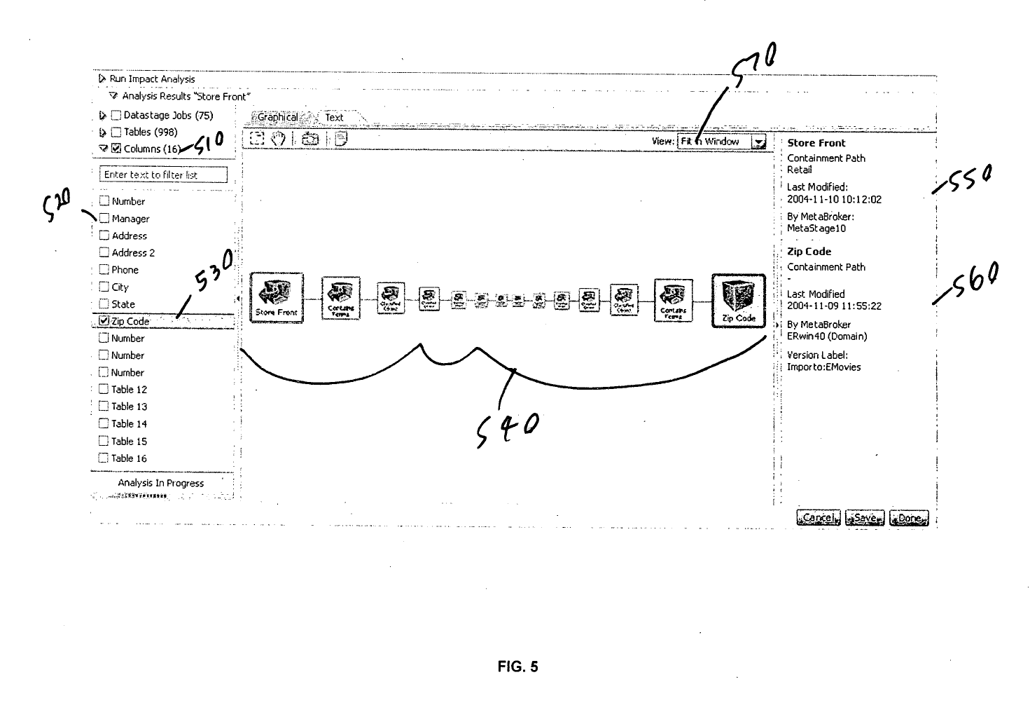

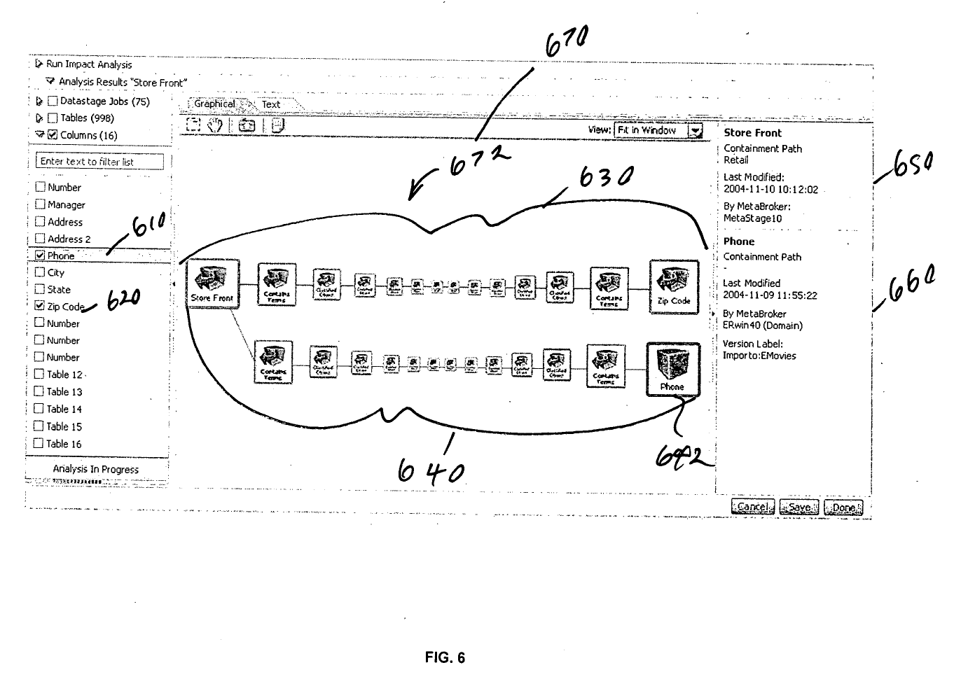

FIG. 5 illustrates an impact analysis path from an original object to a selected object in accordance with certain embodiments. The objects between the original object and the selected object may be referred to as intermediate objects. In a fish eye view, as can be seen in FIG. 5, the visual presentation of the intermediate objects is compressed by reducing a size of the intermediate objects. For example, type of object Columns 510 has been selected, and column objects are listed in the list of objects 520. The Zip Code object 530 has been selected, and the impact analysis system 224 displays an impact analysis path 540 from the original Store Front object to the selected object Zip Code. In FIG. 5, the impact analysis system 224 displays details 550, 560 of the Store Front object and Zip Code object, respectively. Also, in FIG. 5, the graphical view has been selected. FIG. 6 illustrates impact analysis paths from an original object to multiple selected objects in accordance with certain embodiments. In FIG. 6, both the Phone Object 610 and the Zip Code object 620 have been selected for inclusion in the impact analysis view 672 displayed within a path area 670. The impact analysis system 224 displays an impact analysis path 630 from the original Store Front object to the Zip Code object and an impact analysis path 640 from the original Store Front object to the Phone object. The Phone object 642 in the impact analysis path 640 is selected, and the impact analysis system 224 displays details 650, 660 of the Store Front object and the Phone object, respectively.

In block 340, the impact analysis system 224 determines whether the user input indicates that one object has been selected from an impact analysis path displayed in a fish eye view. In certain embodiments, the selection may be made by highlighting an object in a list of objects. In certain embodiments, the selection may be made by using an input device to click on an object in the impact analysis path. If so, processing continues to block 342, otherwise, processing continues to block 344. In block 342, the impact analysis system 224 dynamically updates the impact analysis view to modify objects and details. For example, the selected object may be made larger than other objects (also referred to as unselected objects), illustrated with different colors or highlighting to distinguish from unselected objects or may be represented with a different graphic (e.g., a circle rather than a square), while the unselected objects (which may include the original object) may be made smaller than the selected object, may have different colors and no highlighting to distinguish from the selected object, and may be represented with a different graphic. In certain embodiments, the unselected objects do not include the original object and the size of the selected object is a same size as a size of the original object. Also, if multiple impact analysis paths are illustrated and an object has been selected in a first impact analysis path, if an object in a second impact analysis path is selected, the impact analysis system 224 may align the original object and the selected object (e.g., align horizontally). Also, the impact analysis system 224 modifies the details to provide details of the newly selected object. From block 342, processing continues to block 300. In FIG. 6, the Phone object 642 has been selected, and the impact analysis system 224 dynamically modifies the impact analysis view in path area 670 to show that the Phone object 642 has focus (i.e., has characteristics to enable the rolled over object to be viewed easily with, for example, a larger sized graphic than the graphics of other objects,) and modifies the details area 648 to include details of the Phone object 642.

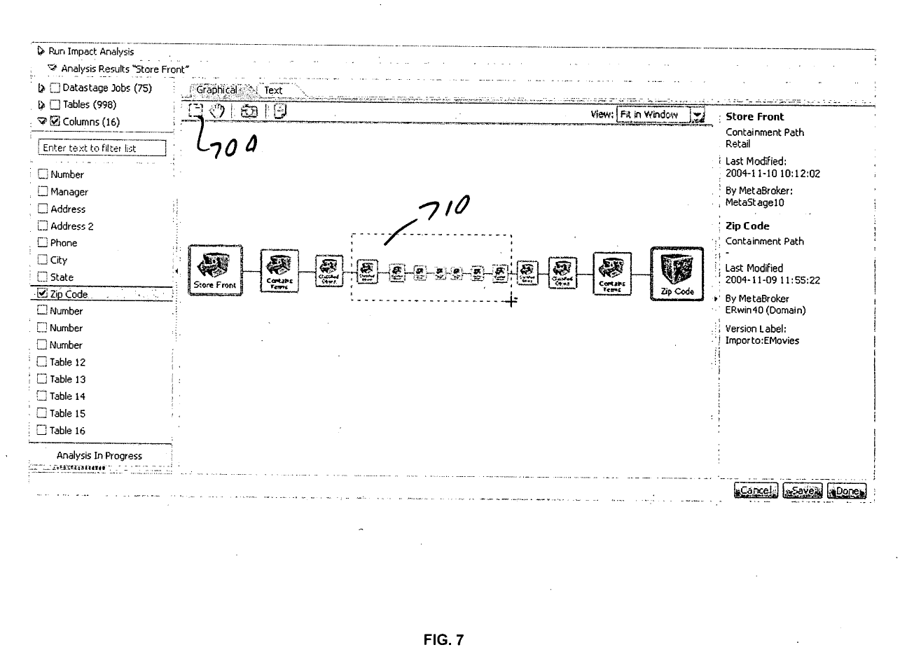

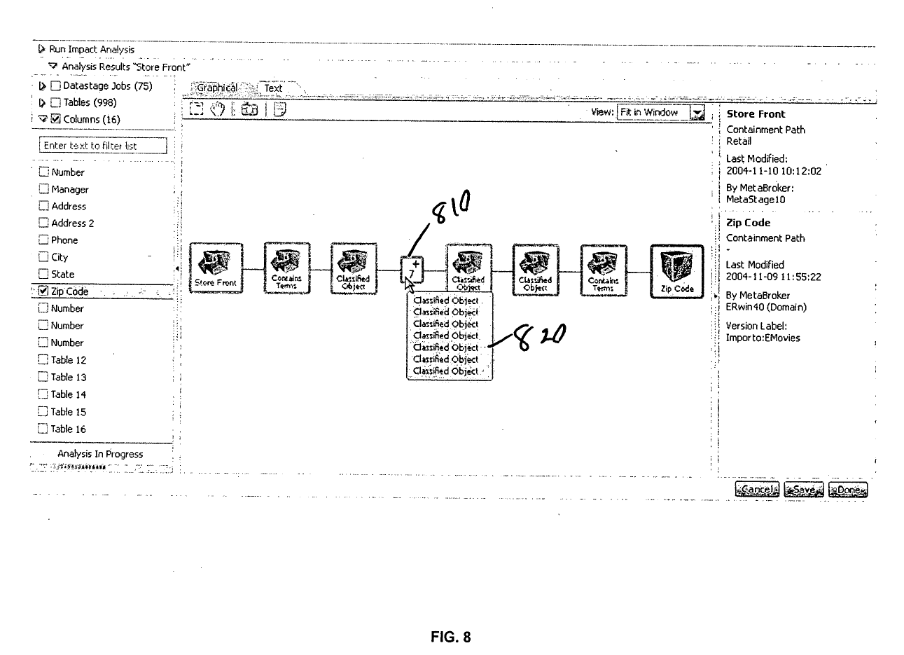

In block 344, the impact analysis system 224 determines whether the user input indicates that a collapse tool and one or more objects have been selected from an impact analysis path. If so, processing continues to block 346, otherwise, processing continues to block 348. In block 346, the impact analysis system 224 collapses the selected objects into a container that is displayed as part of the impact analysis path. From block 346, processing continues to block 300. FIG. 7 illustrates collapse of objects in accordance with certain embodiments. A collapse tool 700 provided by the impact analysis system 224 may be selected and used to draw a rectangle 710 around objects to be collapsed. FIG. 8 illustrates a container 810 that includes collapsed objects in accordance with certain embodiments. In FIG. 8, the objects that were collapsed in FIG. 7 are shown as a container 810 that indicates the number of objects contained in the container, which is seven in this example. The container is also displayed with a plus (+) symbol. The plus symbol may also be referred to as an uncollapse symbol. Thus, the collapse tool allows the user to select a set of objects and collapse them into a container, thereby making additional room for objects that are important to the user.

In block 348, the impact analysis system 224 determines whether the user input indicates that an input device has been used to rollover a container. If so, processing continues to block 350, otherwise, processing continues to block 352. In block 350, the impact analysis system 224 displays information about the content of the container (e.g., a tool tip that lists the objects in the container). From block 350, processing continues to block 300. In FIG. 8, user input rolled over the container 810, and the impact analysis system 224 displayed a tool tip 820 that lists the objects in container 810.

In block 352, the impact analysis system 224 determines whether the user input indicates that a container is to be uncollapsed. In certain embodiments this user input is selection of an uncollapse symbol (e.g., a double click on the plus symbol of a container). If so, processing continues to block 354, otherwise, processing continues to block 356 (FIG. C). In block 354, the impact analysis system 224 displays the items in the container. From block 354, processing continues to block 300.

In block 356 (FIG. 3C), the impact analysis system 224 determines whether the user input has selected a “Fit in window” option in a graphical view. If so, processing continues to block 350, otherwise, processing continues to block 360. In block 350, the impact analysis system 224 displays impact analysis paths in a fish eye view. A fish eye view may be described as display of a connected series of objects in which objects gain visual prominence as they are selected and/or rolled over. From block 350, processing continues to block 300. In FIG. 5, the “Fit in window” option 570 provided by the impact analysis system 224 has been selected and objects in impact analysis path 540 are displayed in a fish eye view. Thus, with the “Fit in window” option, the impact analysis system 224 displays impact analysis paths as a fish eye view to allow all of the objects to fit on the visible computer screen, which avoids the need for a user to use a scrollbar to access portions that otherwise could not be displayed on the visible computer screen. Upon rollover, the impact analysis system 224 enables objects in the background to zoom into focus and allows the user to quickly scan through all objects.

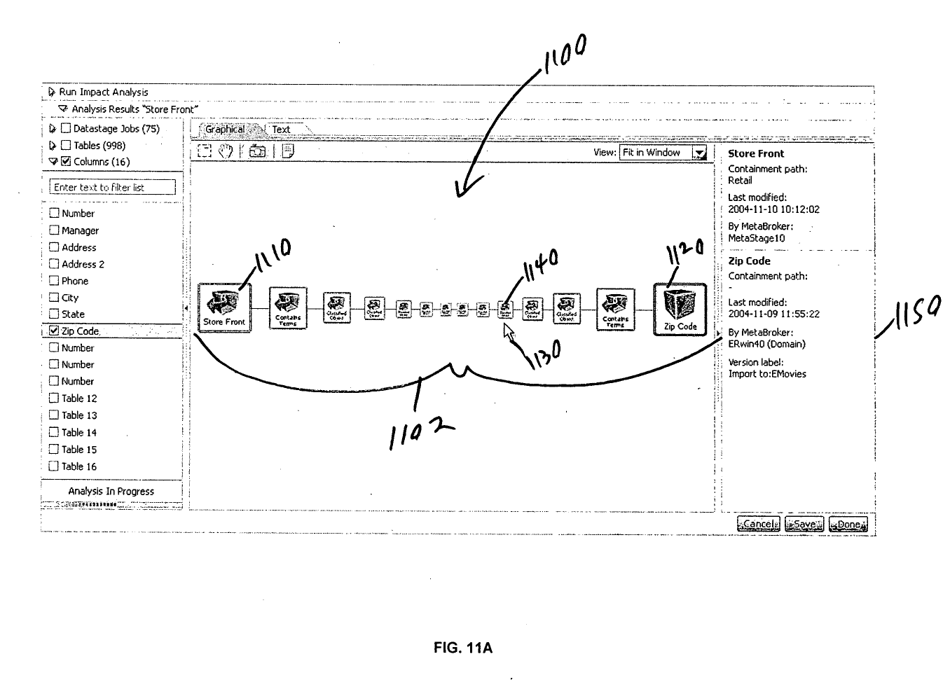

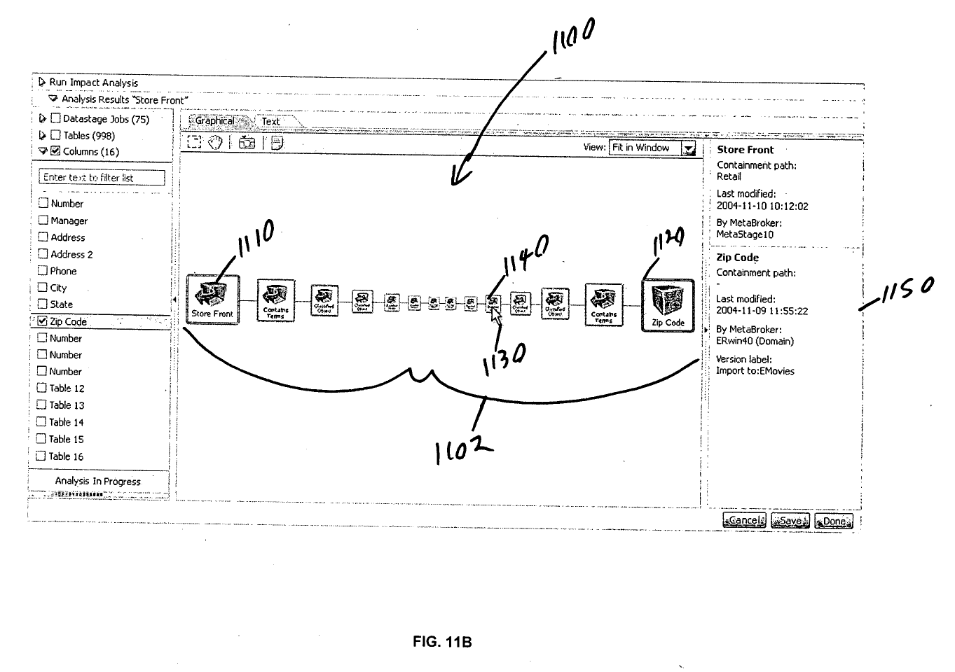

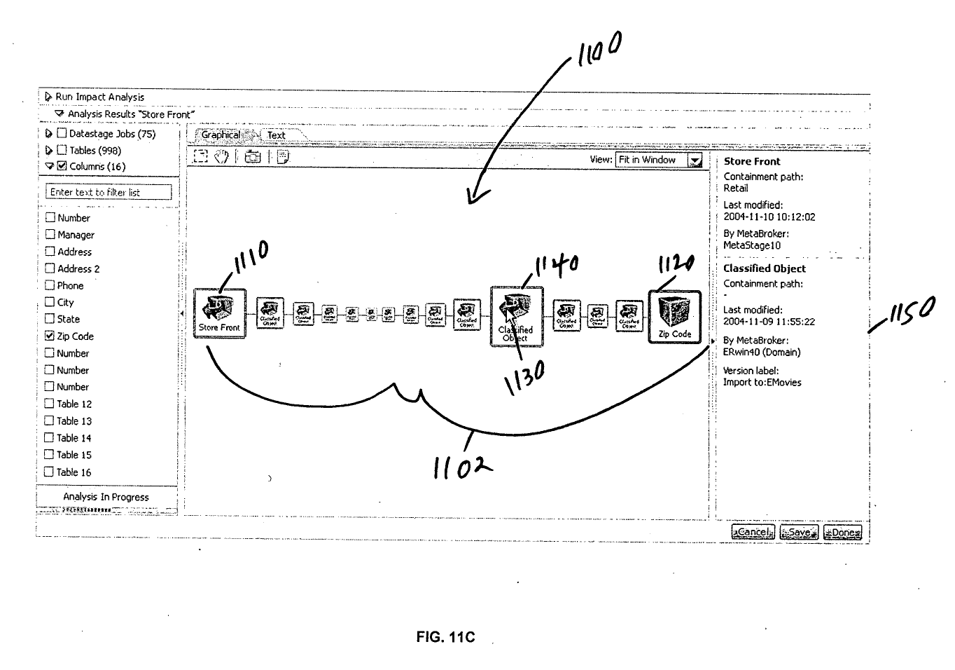

In block 360, the impact analysis system 224 determines whether the user input has indicated that an input device has been used to roll over an object displayed in a fish eye view. In certain embodiments, rolling over an object may be described as using an input device to move a cursor over the object. If so, processing continues to block 362, otherwise, processing continues to block 364. In block 362, the impact analysis system 224 dynamically updates the impact analysis view to modify objects and details. For example, the rolled over object may be made larger than other objects (including a selected object, unselected objects, and the original object), illustrated with different colors or highlighting to distinguish from other objects or may be represented with a different graphic (e.g., a circle rather than a square), while the other objects may be made smaller than the rolled over object, may have different colors and no highlighting to distinguish from the rolled over object, and may be represented with a different graphic. In certain embodiments, the other objects do not include the original object and the size of the rolled over object is a same size as a size of the original object. Also, the impact analysis system 224 modifies the details to provide details of the rolled over object From block 362, processing continues to block 300. FIGS. 11A, 11B, and 11C illustrate an object being rolled over in accordance with certain embodiments. FIG. 11A illustrates an impact analysis view 1100. An impact analysis path 1102 includes an original object 1110 and a selected object 1120. The objects between the original object and the selected object may be referred to as intermediate objects. A cursor 1130 is near an intermediate object 1140, labeled as “Classified Object”. Details 1150 of the selected object are displayed. In a fish eye view, as can be seen in FIG. 11A, the visual presentation of the intermediate objects is compressed by reducing a size of the intermediate objects. In FIG. 11B, the cursor 1130 is shown over the intermediate object 1140. The display of cursor 1130 in FIGS. 11A and 11B is intended to depict a rollover motion over object 1140. FIG. 11C illustrates the results of the rollover. In particular, intermediate object 1140 is now displayed larger than other intermediate objects and details 1160 of the intermediate object are displayed.

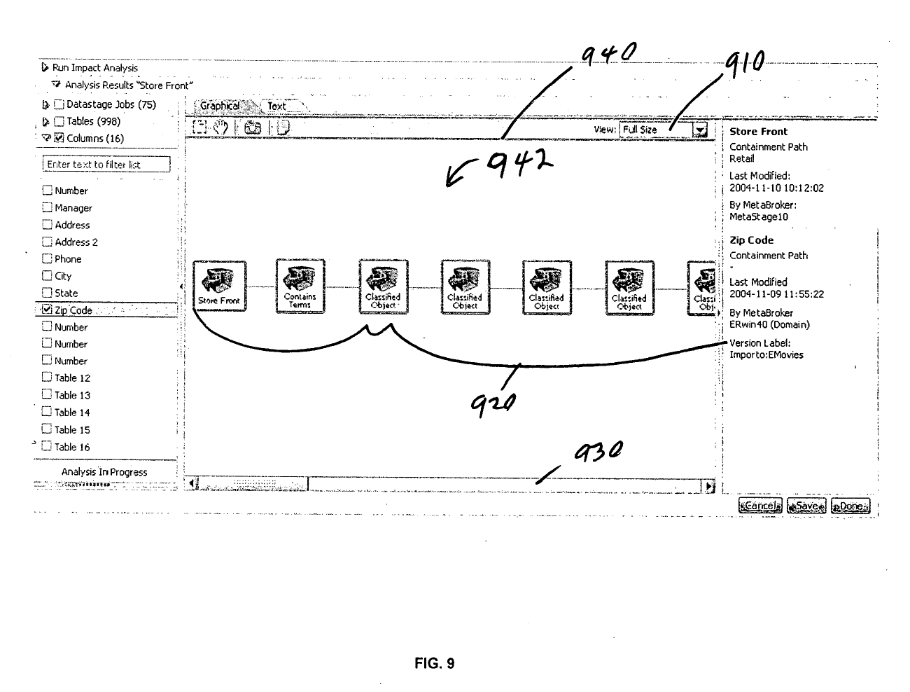

In block 364, the impact analysis system 224 determines whether the user input has selected a “Full size” option in a graphical view. If so, processing continues to block 366, otherwise, processing continues to block 368. In block 366, the impact analysis system 224 displays all objects of each impact analysis path at one hundred percent (100%) actual zoom (i.e., at actual size). From block 350, processing continues to block 300. FIG. 9 illustrates a “Full size” option view in accordance with certain embodiments. In FIG. 9, the “Full size” option 910 provided by the impact analysis system 224 has been selected and all objects in impact analysis path 920 are displayed as part of an impact analysis view, but not all portions of the impact analysis view 942 are visible in the path area 940. A scrollbar 930 may be used to view objects that are not displayed on the visible computer screen.

In block 368, the impact analysis system 224 determines whether the user input has indicated that scroll bar input (i.e., input received when a scroll bar was moved by a user) has been received when the “Full size” option has been selected. If so, processing continues to block 370, otherwise, processing continues to block 372. In block 370, the impact analysis system 224 updates the impact analysis view to show a portion of the impact analysis view based on the scroll bar input. That is, different portions of the impact analysis view are displayed that correspond to the direction of movement of a scroll bar (e.g., a vertical or horizontal scroll bar). From block 370, processing continues to block 300.

In block 372, the impact analysis system 224 determines whether the user input has indicates that scroll bar input (i.e., input received when a scroll bar was moved by a user) has been received in the text view. If so, processing continues to block 374, otherwise, processing continues to block 376. In block 374, the impact analysis system 224 updates the impact analysis view to show a portion of the impact analysis view based on the scroll bar input. From block 374, processing continues to block 300.

In block 376 the impact analysis system 224 determines whether the user input is other user input. If so, processing continues to block 378, otherwise, processing continues to block 300 (FIG. 3A). In block 378, the impact analysis system 224 processes the user input. From block 378, processing continues to block 300.

Thus, embodiments provide a technique to filter large amounts of data using a quick filter textbox, using lists that are categorized by type and number, and by a selection feature (e.g., checkboxes) that allow single or multiple selection. Objects that are selected are used to generate the impact analysis view. This enables greater user control over the path area of the impact analysis view and provides easier comparison opportunities and more focused analysis.

Embodiments enable the user to visually view relationships in one path area in which the impact analysis view is displayed. This is achieved through the fish-eye view of content, which fits all content chosen from the filtering into the visible computer screen through the use of dynamically updating impact analysis paths (e.g., as a user selects portions of the fish-eye view, the impact analysis view dynamically changes). Users may easily switch focus of the analysis by manipulating the fish-eye view. No scrolling up, down, right or left is required, and user error of trying to trace impact analysis paths through a cluttered visual map of relationship impact analysis paths is reduced, while comparison of impact analysis paths is much easier. Embodiments also enable collapsing multiple objects selected by the user into a single container. These containers may be uncollapsed or recollapsed as desired.

Also, embodiments enable a user to view greater context of each object by providing details of any selected and/or rolled over object. This provides greater user orientation and analysis understanding.

Thus, the impact analysis system 224 eases the usability of the impact analysis tool by providing a summarized view of objects by class that is easy to browse and filter, displaying clear visual impact analysis paths through relationships, shows both macro (i.e., full size) and micro (i.e., fit in window) views, enabling management of data by compressing selected objects into containers with filtering, and providing several display options (full screen and fish eye) to manage the view within available computer screen real estate. The impact analysis system 224 allows users to selectively focus on certain parts of the view output by an impact analysis tool rather than the whole view.

### Additional Embodiment Details

The described operations may be implemented as a method, computer program product or apparatus using standard programming and/or engineering techniques to produce software, firmware, hardware, or any combination thereof.

Each of the embodiments may take the form of an entirely hardware embodiment, an entirely software embodiment or an embodiment containing both hardware and software elements. The embodiments may be implemented in software, which includes but is not limited to firmware, resident software, microcode, etc.

Furthermore, the embodiments may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

The described operations may be implemented as code maintained in a computer-usable or computer readable medium, where a processor may read and execute the code from the computer readable medium. The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a rigid magnetic disk, an optical disk, magnetic storage medium (e.g., hard disk drives, floppy disks, tape, etc.), volatile and non-volatile memory devices (e.g., a random access memory (RAM), DRAMs, SRAMs, a read-only memory (ROM), PROMs, EEPROMs, Flash Memory, firmware, programmable logic, etc.). Current examples of optical disks include compact disk—read only memory (CD-ROM), compact disk—read/write (CD-R/W) and DVD.

The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices.

Thus, a computer program product may comprise computer useable or computer readable media, hardware logic, and/or transmission signals in which code may be implemented. Of course, those skilled in the art will recognize that many modifications may be made to this configuration without departing from the scope of the embodiments, and that the computer program product may comprise any suitable information bearing medium known in the art.

The term logic may include, by way of example, software, hardware, and/or combinations of software and hardware.

Certain embodiments may be directed to a method for deploying computing infrastructure by a person or automated processing integrating computer-readable code into a computing system, wherein the code in combination with the computing system is enabled to perform the operations of the described embodiments.

The logic of FIGS. 3A, 3B, and 3C describes specific operations occurring in a particular order. In alternative embodiments, certain of the logic operations may be performed in a different order, modified or removed. Moreover, operations may be added to the above described logic and still conform to the described embodiments. Further, operations described herein may occur sequentially or certain operations may be processed in parallel, or operations described as performed by a single process may be performed by distributed processes.

The illustrated logic of FIG. 3A, 3B, and 3C may be implemented in software, hardware, programmable and non-programmable gate array logic or in some combination of hardware, software, or gate array logic.

The foregoing description of embodiments of the invention has been presented for the purposes of illustration and description. It is not intended to be exhaustive or to limit the embodiments to the precise form disclosed. Many modifications and variations are possible in light of the above teaching. It is intended that the scope of the embodiments be limited not by this detailed description, but rather by the claims appended hereto. The above specification, examples and data provide a complete description of the manufacture and use of the composition of the embodiments. Since many embodiments may be made without departing from the spirit and scope of the embodiments, the embodiments reside in the claims hereinafter appended or any subsequently-filed claims, and their equivalents.

What is claimed is:

1. A computer program product for viewing objects comprising a computer useable medium including a computer readable program, wherein the computer readable program when executed on a computer causes the computer to:
display an impact analysis view that includes at least one impact analysis path from an original object to a first selected object, wherein the impact analysis view is output from an impact analysis tool that analyzes how change to the original object impacts other objects, wherein the at least one impact analysis path includes objects through which the original object and selected object are related, and wherein the impact analysis view is displayed as a fish eye view.

2. The computer program product of claim 1, wherein a first object has been selected in the impact analysis view and wherein the computer readable program when executed on a computer causes the computer to:
in response to receiving selection of a second object in the at least one impact analysis path displayed as a fish eye view,
dynamically update the impact analysis view to modify the objects in the at least one impact analysis path based on the selection; and
provide details about the second object.

3. The computer program product of claim 2, wherein updating the impact analysis view comprises at least one of enlarging a size of the selected object relative to unselected objects, while decreasing a size of one or more of the unselected objects, modifying a color of the selected object to distinguish the selected object from the unselected objects, highlighting the selected object without highlighting the unselected objects, and represented the selected object with a graphic different from a graphic used to represent the unselected objects.

4. The computer program product of claim 3, wherein the unselected objects do not include the original object and wherein the size of the selected object is a same size as a size of the original object.

5. The computer program product of claim 2, wherein the at least one impact analysis path includes intermediate objects, and wherein visual presentation of the intermediate objects is compressed by reducing a size of the intermediate objects.

6. The computer program product of claim 2, wherein at least a first and a second impact analysis path are displayed, wherein an object in the first impact analysis path is currently selected, and wherein the computer readable program when executed on a computer causes the computer to:
in response to receiving selection of an object in the second impact analysis path, align the original object and the selected object in the second impact analysis path.

7. The computer program product of claim 1, wherein the computer readable program when executed on a computer causes the computer to:
in response to receiving rollover of an object in the at least one impact analysis path displayed in an impact analysis view as a fish eye view.
dynamically update the impact analysis view to modify the objects in the at least one impact analysis path based on the rollover; and
provide details about the rolled over object.

8. The computer program product of claim 7, wherein updating the impact analysis view comprises at least one of enlarging a size of the rolled over object relative to other objects, while decreasing a size of one or more of the other objects, modifying a color of the rolled over object to distinguish the rolled over object from the other objects, highlighting the rolled over object without highlighting the other objects, and represented the rolled over object with a graphic different from a graphic used to represent the rolled over objects.

9. The computer program product of claim 1, wherein the computer readable program when executed on a computer causes the computer to:
in response to receiving input for one or more filters, generate a list of objects, wherein the one or more filters comprise at least one of a list of object types and a quick filter text box;
receive selection of one or more objects from the list of objects; and
display one or more impact analysis paths from the original object to the one or more objects selected from the list of objects.

10. The computer program product of claim 1, wherein the computer readable program when executed on a computer causes the computer to:
in response to receiving selection of a grab tool, update the impact analysis view to show a portion of the impact analysis view based on user input.

11. The computer program product of claim 1, wherein the computer readable program when executed on a computer causes the computer to:
in response to receiving selection of a snapshot tool, generate a snapshot of the impact analysis view.

12. The computer program product of claim 1, wherein the computer readable program when executed on a computer causes the computer to:
in response to receiving selection of a generate report tool, generate a report of the impact analysis view.

13. The computer program product of claim 1, wherein the computer readable program when executed on a computer causes the computer to:
in response to receiving selection of a graphical view, display a graphical view of the impact analysis view.

14. The computer program product of claim 13, wherein the computer readable program when executed on a computer causes the computer to:
in response to receiving selection of a collapse tool and one or more objects on the at least one impact analysis path, collapse the selected one or more objects into a container;
in response to receiving rollover of the container, display information about content of the container; and
in response to receiving selection of an uncollapse symbol, display the one or more objects in the container.

15. The computer program product of claim 13, wherein the impact analysis view is displayed as a fish eye view in response to receiving selection of a fit in window option.

16. The computer program product of claim 13, further comprising:
in response to receiving selection of a full size option, display all of the one or more objects in the at least one impact analysis path at one hundred percent actual zoom, wherein one or more of the objects are not visible in a path area displayed on a computer screen; and
in response to receiving scroll bar input, updating the impact analysis view to show a portion of the impact analysis view based on the scroll bar input.

17. The computer program product of claim 1, further comprising:
in response to receiving selection of a text view, display text view of the impact analysis view; and
in response to receiving scroll bar input, update the impact analysis view to show a portion of the impact analysis view based on the scroll bar input.

18. A method for viewing objects, comprising:
displaying an impact analysis view that includes at least one impact analysis path from an original object to a first selected object, wherein the impact analysis view is output from an impact analysis tool that analyzes how change to the original object impacts other objects, wherein the at least one impact analysis path includes objects through which the original object and selected object are related, and wherein the impact analysis view is displayed as a fish eye view.

19. The method of claim 18, wherein a first object has been selected in the impact analysis view and further comprising:
in response to receiving selection of a second object in the at least one impact analysis path displayed as a fish eye view,
dynamically updating the impact analysis view to align the original object and the selected; and
providing details about the second object.

20. A system for viewing objects, comprising:
a computer screen; and
logic capable of performing operations, the operations comprising:
displaying an impact analysis view that includes at least one impact analysis path from an original object to a first selected object, wherein the impact analysis view is output from an impact analysis tool that analyzes how change to the original object impacts other objects, wherein the at least one impact analysis path includes objects through which the original object and selected object are related, and wherein the impact analysis view is displayed as a fish eye view
